(19) United States
(12) Patent Application Publication
(10) Pub. No.: US 2025/0100929 A1
(43) Pub. Date: Mar. 27, 2025

(54) HARVESTED FLY ASH FOR USE IN CONCRETE

(71) Applicant: Cinder Residuals, LLC, Fairfield, TX (US)

(72) Inventor: Matthew Tyler LEY, Stillwater, OK (US)

(21) Appl. No.: 18/891,400

(22) Filed: Sep. 20, 2024

Related U.S. Application Data
(60) Provisional application No. 63/584,686, filed on Sep. 22, 2023.

(51) Int. Cl. C04B 18/08; C04B 7/02; C04B 28/04

(52) U.S. Cl. CPC C04B 18/08; C04B 7/02; C04B 28/04; C04B 2201/52

(57) ABSTRACT

Fly ash, a byproduct of coal combustion, has extensive and beneficial use in concrete and cement mixes. Closure of coal-powered power plants has caused a significant reduction in live fly production ash and turned attention of concrete producers to harvested fly ash, which can be excavated from closed coal powered plant's impoundment to satisfy the need in the industry for fly ash. However, challenges arise from the unique qualities of harvested fly ash, which according to the art requires extensive grinding and other processing measures to render it suitable for concrete applications. This invention discloses the use of harvested fly ash in concrete where the particle size percentage of the fly ash is greater than that generally accepted in the art. Also disclosed is a method for use of this harvested fly ash as a supplementary cementitious material in concrete mixes.

### FIELD OF INVENTION

Harvested fly ash in concrete and cement mixes.

### BACKGROUND OF THE INVENTION

Cement is a finely ground, powdery substance made primarily from limestone and clay that, when mixed with water, forms a paste capable of hardening and binding other materials together. The production of cement involves crushing and blending raw materials, heating them in a kiln to produce clinker, and then grinding the clinker with gypsum to create the final product. Its ability to set and harden over time makes it an essential component in building foundations, roads, bridges, and numerous other infrastructure and construction applications. Cement is a crucial ingredient in concrete and mortar, providing structural integrity and durability to construction projects.

Concrete, subsequently, is a building material composed of a mixture of cement, water, and aggregates such as sand, gravel, or crushed stone. When combined, these ingredients form a paste that hardens over time through a chemical reaction called hydration. Once set, concrete forms a strong, durable substance capable of withstanding significant structural loads and various environmental conditions. Its adaptability allows it to be molded into diverse shapes and sizes, making it a fundamental material in construction for foundations, roads, bridges, and numerous other infrastructure projects.

Fly ash is a fine, powdery byproduct generated from the combustion of coal in power plants. It consists of small, spherical particles that are primarily composed of calcium oxide (CaO), silicon dioxide (SiO₂), aluminum oxide (Al₂O₃), and iron oxide (Fe₂O₃), along with trace amounts of other elements. The utilization of harvested fly ash has gained significant attention due to its potential as a sustainable resource in various industries, including construction, agriculture and manufacturing. Fly ash has become a critical component in concrete mixes since it imparts numerous beneficial properties to the concrete. The use of fly ash also allows for a reduced amount of cement to be used in concrete mixes.

The supply of live fly ash, taken out directly from power plant operations, has been declining and is no longer sufficient to satisfy the demand. For decades, the amount of fly ash generated during power plant operations has exceeded demand, causing large amounts of fly ash being disposed of and stored in impoundments located in the vicinity of power plants. This traditional disposal method creates certain environmental challenges as it can potentially lead to the release of harmful pollutants, including heavy metals and leachable contaminants. Furthermore, the storage of fly ash requires substantial land area, which can become a limitation in regions with scarce land availability and hamper economic development. For these reasons, as well as the growing demand for fly ash due to the closure of power plants, leads to increased interest in the use of coal combustion products or “harvested ash” from storage impoundments for use in concrete and construction materials.

There are a few important differences between live and harvested fly ash. The terms “live fly ash” and “harvested fly ash” refer to different states and histories of these two types of materials. Live fly ash is collected directly from the stacks of power plants as coal combustion occurs and ash is removed from the process. It is typically a very fine powder, with no moisture, which needs to be captured before it can be used. On the other hand, harvested fly ash is collected from the power plant stacks and stored in impoundments or ponds and then removed and processed for usage. Harvested fly ash has high moisture content (above 3% by mass) and is often sprayed with water to avoid dust generation. During storage, harvested ash often becomes clumped in larger particle sizes, which are typically ground to create a finer powder. Hence, “live fly ash” and “harvested fly ash” require different processing methodological approaches, with live ash requiring collecting, while harvested ash requires drying and grinding.

However, challenges in this newly emerging use of harvested fly ash exist. Harvested ash, collected at landfills and impoundments as noted above, has different qualities as compared to live ash. Harvested ash typically necessitates drying and griding in order to achieve optimal performance and consistent behavior when incorporating this type of ash into various concrete applications. In addition, physical and chemical characteristics of fly ash can vary depending on the coal source, combustion process, and post-combustion treatment. This variability can impact the compatibility of the fly ash with other materials found in concrete and its overall performance in specific applications, which may require additional processing steps to create a usable product.

Therefore, there is a need for innovative solutions and technologies that address these and other challenges associated with utilizing harvested fly ash effectively in concrete. The present invention seeks to provide a novel approach to use harvested fly ash while providing adequate performance while reducing the cost and energy required for drying and grinding. Further, this invention describes a unique method and composition that leverages the inherent properties of fly ash to enhance its usability and value in multiple fields.

### SUMMARY OF THE INVENTION

The present invention provides a method for utilization of harvested fly ash in concrete. It also provides for a fly ash not meeting current ASTM C618 standards but useable for concrete mixtures. Fineness of fly ash refers to the particle size distribution and overall particle size, impacting its performance in concrete, and particular slump (workability, flowability) (ASTM C143) electrical resistivity (AASHTO T358), and the compressive strength (ASTM C39). The particle size distribution is reported to affect the concrete's strength and workability when fly ash is integrated into a concrete mix, as well as resistivity. Finer fly ash is expected to enhance properties like compressive strength, durability and workability.

The art teaches that increased fineness of fly ash improves both strength and slump, as for example is taught in Mccarthy et al, (2018) “Dry-processing of long-term wet-stored fly ash for use as an addition in concrete”, Cement and Concrete Composites, vol. 92, pp. 205-215. However, an unexpected finding of this disclosure is that even unprocessed or only minimally processed fly ash, in regard to its particle size, has a slump which is higher than Portland cement alone and compressive strength comparable to fully processed fine fly ash. Though this fly ash does not comply with the current ASTM C 618 standard of fineness, namely a retention of less than 34% when wet-sieved on 45 μm (#325) sieve, it still imparts the needed properties to the concrete.

In one embodiment, non-grinded or minimally grinded harvested fly ash, having larger particle size, shows superior slump performance as compared to mixtures with Portland cement alone, which, in turn, leads to increased workability and flowability of the concrete mixture despite the ash fineness being out of spec per ASTM C 618.

In another embodiment, concrete made of this non-ASTM C618 compliant fly ash demonstrated compressive strength comparable to that of ASTM C 618 compliant fly ash, in regards to fineness requirements, and within 75% of required compressive strength of a mixture with Portland cement alone. The 75% compressive strength limit matches the compressive strength reduction allowed in ASTM C 618 for mixtures that contain fly ash compared to mixtures with only Portland cement.

In another embodiment, the invention contemplates block and brick produced using concrete made with coarser unprocessed, or partially processed harvested fly ash. Concrete products produced with this type of ash, including but not limited to block and brick, are expected to have quality fully comparable to that of products produced with fly ash processed using standard accepted manufacturing practices required under ASTM C 618.

The use of harvested ash, particularly fly ash that requires less than standard processing, will contribute to resource efficiency by conserving energy as well as will mitigate the environmental impact associated with traditional production methods. The utilization of coarse harvested fly ash in concrete mixtures will reduce processing costs, environmental impact, and as a consequence will benefit manufacturers, customers and the environment.

### BRIEF DESCRIPTION OF THE DRAWINGS

FIG. 1: Compressive strength results for mixes in Stage I.

FIG. 2: The effect of fineness on slump, as disclosed in Stage II Results.

FIG. 3: The effect of fineness on the compressive strength, as disclosed in Stage II Results.

FIG. 4: The effect of fineness on the electrical resistivity, as disclosed in Stage II Results.

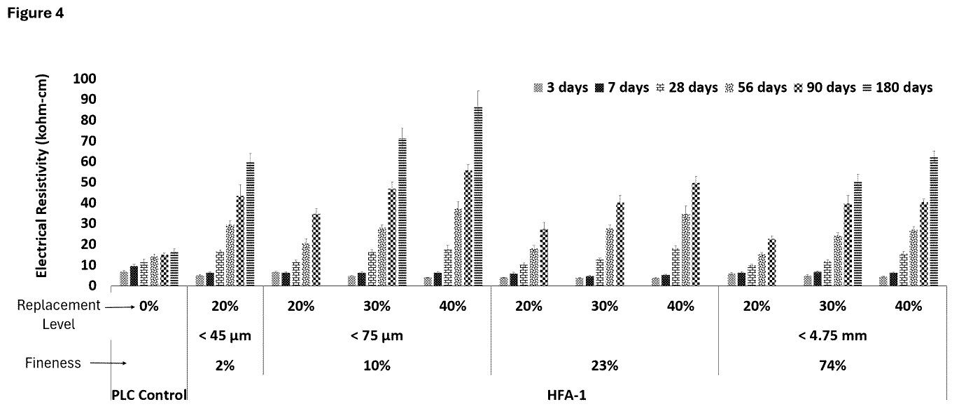

### DETAILED DESCRIPTION OF THE INVENTION

As used in the present specification, the following words and phrases are generally intended to have the meanings as set forth below, except to the extent that the context in which they are used indicates otherwise.

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” or “some embodiments” or “a certain embodiment” means that a particular feature, structure or characteristic described in connection with the embodiment is included in at least one embodiment. Thus, the appearances of the phrases “in one embodiment” or “in an embodiment” or “in some embodiments” or “in a certain embodiment” in various places throughout this specification are not necessarily all referring to the same embodiment. Furthermore, the particular features, structures, or characteristics may be combined in any suitable manner in one or more embodiments.

Also, as used in this specification and the appended claims, the singular forms “a,” “an,” and “the” include plural referents unless the content clearly dictates otherwise.

When ranges of values are disclosed, and the notation “from n1 . . . to n2” or “between n1 . . . and n2” is used, where n1 and n2 are the numbers, then unless otherwise specified, this notation is intended to include the numbers themselves and the range between them. This range may be integral or continuous between and including the end values.

As used herein, “about” means±20% of the stated value, and includes more specifically values of ±10%, ±5%, ±2% and ±1% of the stated value.

The term “air-entraining agent” refers to a chemical that will entrain air in cementitious compositions. Air entrainers can also reduce the surface tension of a composition at low concentration. Air-entraining admixtures are used to purposely entrain microscopic air bubbles into concrete. Air-entrainment dramatically improves the durability of concrete exposed to moisture during cycles of freezing and thawing. In addition, entrained air greatly improves a concrete's resistance to surface scaling caused by chemical deicers. Air entrainment also increases the workability of fresh concrete while eliminating or reducing segregation and bleeding. Materials used to achieve these desired effects can be selected from synthetic or natural resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Air entrainers are added in an amount to yield a desired level of air in a cementitious composition. Examples of air entrainers that can be utilized in the present invention include, but are not limited to MB AE 90, MB VR and MICRO AIR®.

The term “cementitious binder” refers to a chemical substance or substances used for construction that sets, hardens, and adheres to other materials to bind them together. In some embodiments, cementitious binders are chosen from manufactured materials, such as lime and Portland cement. In some embodiments, cementitious binders are chosen from processed by-products of manufacturing and power generation. In some embodiments, the lime is chosen from ground limestones, calcined limestones, quicklime, and hydrated lime.

The term “truck” refers to a motor vehicle designed to transport freight, carry specialized payloads, or perform other utilitarian work.

The term “silo” refers to a structure for storing bulk materials.

The fineness of fly ash, a characteristic critical for its various industrial applications, refers to the particle size distribution and overall particle dimensions of this byproduct generated from coal combustion. Finer particles are thought to exhibit greater reactivity and surface area, allowing for improved interaction with other materials. Coarser particles, on the other hand, have been taught in the art to negatively impact workability, structural properties and the overall performance of the end products. In construction materials, such as cement mixtures, the fineness of fly ash can significantly impact the mechanical properties of the resulting concrete. Finer fly ash particles are expected to enhance reactivity, facilitating the formation of additional cementitious compounds and leading to improved compressive strength, durability and reduced permeability. The fineness of fly ash also affects slump (workability, flowability) and mixability of concrete, with finer particles reported to enhance the fluidity of mixtures.

Processing of fly ash may include multiple steps, including drying, grinding, reduction of carbon content and others. Fineness, in particular, can be adjusted or modified by grinding. The common acumen in the concrete industry is that increased fineness improves both strength and slump, which is further supported by research publications. For instance, Mccarthy et al (2018) states: “Tests on concrete found that both consistence (slump) and compressive (cube) strength increased with processing and tended to follow fly ash fineness”, and further “The consistence of concrete (slump) increased with fly ash fineness following processing, irrespective of the method used. Small differences between reference and processed fly ash concrete strengths were noted at early test ages, with benefits tending to become more noticeable with time. Concrete strengths at 28 days for reference and processed fly ashes could be related to the material's fineness (45 μm sieve retention)”.

It is also known in the art that fly ash must be ground to a certain fineness in order for the final product to comply with standardized requirements. For instance, ASTM C 618, “Standard Specification for Coal Fly Ash and Raw or Calcined Natural Pozzolan for Use in Concrete” requires among other things that at least 66% of fly ash particles to be less than 45 μm in size or, in other words, to have a retention of 34% or less on #325 sieve. The sieve #325, or fineness test, is an important part of this disclosure and can be summarized as follows. This test involves passing a sample of fly ash through a 45-micron (325 mesh) sieve to evaluate its particle size. Specifically, one gram of dry fly ash is placed on a sieve, wetted and washed using a stream of water to enable passage through the sieve of particles 45 micron and smaller. Particles larger than 45 microns are retained on the sieve, oven dried, and the dry weight of the remaining mass is compared to the original one gram to determine the percentage of material that has passed through the sieve.

The fineness test described above is an integral part of ASTM C 618, a standard specification developed by ASTM International defines the requirements for fly ash and natural pozzolans used as supplementary cementitious materials (SCMs) in concrete, which can be briefly outlined as follows:

Scope. ASTM C618 specifies the requirements for fly ash and natural pozzolans to be used as partial replacements for Portland cement in concrete. It covers the chemical and physical properties of these materials to ensure their suitability and performance.

Ash classification. Fly Ash is classified into two types: (i) Type F: Typically derived from burning anthracite or bituminous coal; it generally has lower calcium content and higher silicon dioxide (SiO₂) and alumina (Al₂O₃) content; (ii) Type C: Generally produced from burning lignite or sub-bituminous coal; tends to have higher calcium content and also contains significant amounts of SiO₂ and Al₂O₃. Natural Pozzolans are also classified, but the specification mainly focuses on their chemical composition and performance characteristics.

Chemical Requirements. The specification sets limits on the chemical composition of the fly ash or natural pozzolan, including the maximum percentages of silicon dioxide, aluminum oxide, iron oxide, and calcium oxide. These limits are intended to ensure adequate performance in concrete.

Physical Requirements. ASTM C 618 specifies physical properties such as fineness, loss on ignition, and moisture content. These properties affect the workability and durability of the concrete.

Performance Requirements: The materials must meet certain performance criteria, including compressive strength. This includes ensuring they do not adversely affect the strength or durability of the concrete.

Testing and Certification. The specification outlines the methods for testing the fly ash and natural pozzolans to ensure they meet the required standards. It also provides guidelines for the certification and documentation of these materials. ASTM C 618 ensures that fly ash and natural pozzolans used in concrete contribute to the desired properties and performance of the finished product while also promoting sustainability through the use of industrial by-products.

It has been discovered that out of spec harvested fly ash (ASTM C 618 non-compliant fly ash), namely too coarse to comply with fineness requirement of ASTM C 618, outperforms Portland cement in slump testing and has a comparable compressive strength to fly ash mixes made with ash having a compliant fineness as required by ASTM C 618. In one instance, during preliminary testing on mixtures of concrete containing unprocessed and minimally processed harvested fly ash, unexpected test results were observed. The experiment was set up to comprise a standard 20% fly ash replacement of Portland cement, a rate customary accepted in numerous commercial concrete applications. When concrete comprising said ash was tested, it was noted that while its slump was lower than ashes compliant with ASTM C618, it was still higher and superior to a control mix with Portland cement alone. Moreover, the results showed that overgrinding of fly ash to about 2% retention rate on sieve #325 lead to significantly reduced slump as compared to mixes with other fly ashes, as well as the control mix. In addition, the compressive strength of concrete made with unprocessed or minimally processed fly ash was essentially the same as for those made with finely ground fly ash, and well within the range of at least 75% of compressive strength of mixtures that contain Portland cement alone, as required by ASTM C 618. Finally, testing of electric resistivity of experimental mixes, a method to assess mass transport into concrete and thus estimate resistance of concrete against ion ingress and ultimately its durability, have shown that ASTM C 618 non-compliant fly ash improves resistivity as compared to the control mix with Portland cement alone. The fact that coarser and less processed fly ash showed sufficient slump and improved electric resistivity, as compared to the control mix, and virtually the same compressive strength as compared to the fully processed and finely ground ash, was unexpected.

Processing of fly ash is costly and environmentally taxing mechanism. Particularly, ash grinding involves significant use of energy, generates CO₂ emissions and creates air and noise pollution. The present invention improves the understanding of utilization of fly ash through innovative control of its fineness. The fact that coarse, reduced processed harvested ash used in concrete mixes shows slump superior to that of Portland cement alone, and the resulting concrete is comparable in its compressive strength to concrete made with finely ground ash that meets ASTM C 618 allows for significant reduction of ash processing, reducing cost to manufacturers and customers and lowering environmental impact of harvested fly ash utilization in concrete and other industrial applications.

Disclosed herein is a method of making concrete, comprising mixing the following materials to a homogenous mixture, contemporaneously or consecutively:
a. cementitious binder comprising 5%-30% of the total concrete mixture weight;
b. fly ash having a particle size distribution retained rate of more than 34% percent when wet-sieved on 45 μm sieve and wherein said fly ash is present in a combined range of 5% to 50% by weight based on the total weight of the cementitious binder;
c. water in a combined range of 20% to 70% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 5% to 95% of the total concrete mixture by weight.

In some embodiments, the method comprises mixing the following materials to a homogenous mixture, contemporaneously or consecutively:
a. cementitious binder comprising 10%-17% of the total concrete mixture weight;
b. fly ash having a particle size distribution retained rate of more than 34% percent when wet-sieved on 45 μm sieve and wherein said fly ash is present in a combined range of 20% to 40% by weight based on the total weight of the cementitious binder;
c. water in a combined range of 40% to 50% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 60% to 85% of the total concrete mixture by weight.

In some embodiments, the method further comprises adding air-entraining agents to improve freeze-thaw resistance, wherein the air-entraining agents create a volume of air comprising between 1% and 12% of the mixture.

In some embodiments, the fly ash is dried to 3% or less water content.

In some embodiments, the cementitious binder is chosen from ordinary Portland cement, Portland limestone cement, blended cement, and calcium sulfoaluminate cement.

In some embodiments, the cementitious binder is ordinary Portland cement.

In some embodiments, wherein the concrete has a slump of 1-9 inches.

In some embodiments, the fly ash is retained, when wet-sieved on 45 μm sieve, at a rate of more than 35%, 45%, 55%, 65%, 75%, 85% or 90%.

In some embodiments, the retention rate is more than 45%, 65% or 85%.

In some embodiments, the retention rate is more than 45%.

Also disclosed herein is a fly ash comprising:
i. a chemical composition comprising silica, alumina and iron oxides being a minimum of 50% of fly ash mass;
ii. moisture of up to 3%;
iii. a loss on ignition of up to 6%;
iv. a sulfur trioxide concentration of not more than 5%;
V. a strength activity index of no less than 75% as compared to a control mixture with Portland cement alone;
vi. an autoclave expansion of no more than 0.8%;
vii. a water requirement of no more than 105% as compared to a control mixture with Portland cement alone; and
viii. having a particle size distribution retention rate of more than 34% percent when wet-sieved on 45 μm sieve.

In some embodiments, the fly ash is class C fly ash.

In some embodiments, the fly ash is class F fly ash.

In some embodiments, the fly ash is harvested fly ash.

Also disclosed herein is a storage silo comprising a fly ash disclosed herein.

Also disclosed herein is a truck comprising a dry bulk enclosed trailer loaded with a fly ash disclosed herein.

Also disclosed herein is a concrete mix comprising:
a. cementitious binder comprising 5%-30% of the total concrete mixture weight;
b. fly ash having a particle size distribution retained rate of more than 34% percent when wet-sieved on 45 μm sieve and wherein said fly ash is present in a combined range of 5% to 50% by weight based on the total weight of the cementitious binder;
c. water in a combined range of 20% to 70% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 5% to 95% of the total concrete mixture by weight.

In some embodiments, the concrete mix comprises:
a. cementitious binder comprising 10%-17% of the total concrete mixture weight;
b. fly ash having a particle size distribution retained rate of more than 34% percent when wet-sieved on 45 μm sieve and wherein said fly ash is present in a combined range of 20% to 40% by weight based on the total weight of the cementitious binder;
c. water in a combined range of 40% to 50% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 6% to 85% of the total concrete mixture by weight.

In some embodiments, the concrete mix has a slump measured by (i) filling a slump cone with fresh concrete in three layers, (ii) compacting each layer with a tamping rod, (iii) vertically removing the slump cone, (iv) allowing the concrete to slump, and (v) measuring the decrease in concrete height, of between 1 and 9 inches.

In some embodiments, the concrete mix has a compressive strength between 3,000 and 8,000 PSI.

Also disclosed herein is a block or brick comprising a concrete mix as disclosed herein.

### Examples

### Example 1: Materials and Methods

### Materials

The harvested fly ash samples used for laboratory mixes in this study originated from the same source and processed through sieving or grinding to obtain various fineness levels. An assessment of the fly ash was conducted using the automated scanning electron microscope (ASEM) to ascertain the composition of 11 chemical oxides (including SiO₂, Al₂O₃, Fe₂O₃, CaO, MgO, SO₃, Na₂O, K₂O, TiO₂, P₂O₅, and SrO) present in the sample. Chemical composition is disclosed in Table 1. According to ASTM C 618 standards, the harvested fly ash used in this study is Class F fly ash since it contains less than 18% CaO.

TABLE 1
Chemical Composition

| | | CaO | SiO₂ | Al₂O₃ | Fe₂O3 | Na₂O | MgO | P₂O₅ | SO₃ | K₂O | TiO₂ | SrO |
|---|---|---|---|---|---|---|---|---|---|---|---|---|
| Source | Class | (%) | (%) | (%) | (%) | (%) | (%) | (%) | (%) | (%) | (%) | (%) |
| HFA-1 | F | 11.1 | 54.4 | 22.3 | 5.8 | 0.05 | 4.2 | 0 | 0.18 | 1.5 | 0.4 | 0.11 |

The cement used in all laboratory concrete mixes is type 1L Portland Limestone Cement (PLC) which is a blended cement in which finely ground limestone (5 to 15%) is an integral component within the cement. This type of cement has been designed to have equivalent performance to existing cements and is rigorously tested to verify its performance where it is manufactured according to both ASTM C595 and AASHTO M 240 Standard Specifications for Blended Hydraulic Cements. All laboratory concrete mixtures in this study utilized a single source for both coarse and fine aggregates. The coarse aggregate was #57 crushed limestone with a nominal maximum size of 25 mm (1 inch), while the fine aggregate was natural sand conforming to ASTM C33 specifications for fine aggregates.

### Method 1: Sample Preparation

In order to adhere to the requirements outlined in the ASTM C 618 standard specification for coal fly ash and raw or calcined natural pozzolans, the harvested fly ash samples in this work underwent a specific process before used in the concrete. Initially, fly ash stored in landfills typically contains 10 to 20% moisture, which serves the dual purpose of controlling dust and optimizing compaction to maximize storage capacity. Alternatively, fly ash stored in ponds or surface impoundments is often transported to these sites as a slurry from the plant collection system. Once in the pond, the fly ash settles, and, depending on the type of fly ash and storage method, the reclamation process may include dewatering or drying. In this experiment, an oven is used to dry the ashes at 230° F. for 24 hours to achieve a moisture of 0%.

The study was conducted in two stages. Stage I involved creating nine concrete mixes using harvested fly ash samples from the same source, each with varying fineness levels. These samples were categorized into three groups based on their fineness: low fineness (<15%), medium fineness (30%<Fineness <36%), and high fineness (>75%). The compressive strength of these samples was tested over a period of 28 days. Stage II was based on the findings from Stage I and involved creating an additional eleven mixes. One mix without fly ash was used as a control, while the other ten mixes incorporated fly ash from the same source. Samples were prepared with three different fineness levels (10%, 23%, and 74%), with three concrete mixes created for each fineness level at replacement rates of 20%, 30%, and 40%. Additionally, one sample was prepared with ash ground to a very fine particle size of 2% fineness to investigate the impact of ultra-fine particles on concrete properties. These mixes were tested for various fresh and hardened concrete properties, including slump, unit weight, air content, and water-to-cement ratio using the Phoenix, in addition to the compressive strength and electrical resistivity over a 180-day period.

### Method 2: Sieving and Grinding

To prepare the samples with different fineness levels for the concrete mixes, sieving and grinding techniques were employed. In Stage I, the materials were used in three conditions: high fineness, which consisted of the material as received, medium fineness; obtained by sieving the material through a #100 sieve, and low fineness; achieved by sieving through a #200 sieve. In Stage II, samples were prepared with three specific fineness levels: 10% fineness by sieving through a #200 sieve, 74% fineness by using the ash after sieving through a #4 sieve, and 23% fineness by blending fine ash (10% fineness) with coarse ash (74%) ground for 250 revolutions in equal proportions (50/50 by mass). This blend aimed to achieve a fineness number that was intermediate between the coarse and fine ash and met the ASTM C618 standard fineness limit of 34%. Three concrete mixes were created for each fineness level at replacement rates of 20%, 30%, and 40%. Additionally, one sample was prepared with ash ground to a very fine particle size of 2% fineness to investigate the impact of ultra-fine particles on both the fresh and hardened properties of the concrete. For grinding the F. C. Bond Ball Mill was utilized. This mill features a 64 oz (2L) capacity and a 12″×12″ cast iron drum, operating at 70 revolutions per minute. The grinding charge consisted of 285 iron balls, varying in size from ¾ inch to 1½ inch in diameter, with a total weight of approximately 44.5 lbs. (20,125 grams). In this experiment, a dry feed of 3 lbs. was processed and ground it for 20 minutes to produce ultra-fine ash. Table 2 gives a summary for all mixes conducted through this study with its two stages.

TABLE 2

| | | |
|---|---|---|
| Sample Name | Replacement Level | Fineness |

Stage I Mixes

| | | |
|---|---|---|
| HFA1 - Low Fineness 1 | 20% | 10% |
| HFA1 - Low Fineness 2 | 20% | 15% |
| HFA1 - Low Fineness 3 | 20% | 13% |
| HFA1 - Medium Fineness 1 | 20% | 33% |
| HFA1 - Medium Fineness 2 | 20% | 31% |
| HFA1 - Medium Fineness 3 | 20% | 35% |
| HFA1 - High Fineness 1 | 20% | 86% |
| HFA1 - High Fineness 2 | 20% | 91% |
| HFA1 - High Fineness 3 | 20% | 75% |

Stage II Mixes

| | | |
|---|---|---|
| <45 μm | 20% | 2% |
| <75 μm | 20%, 30%, 40% | 10% |
| 75 μm < Particle Size < 4.75 mm | 20%, 30%, 40% | 23% |
| <4.75 mm | 20%, 30%, 40% | 74% |

### Method 3: Fineness Test

In this research, the particle size distribution of the fly ashes used was examined through the fineness test. The fineness of harvested fly ash is assessed using a wet sieving procedure to determine the amount of material retained on a #325 sieve. This test involves placing a measured amount of dry fly ash (1 gram) in the sieve and wet sieving it through the #325 sieve for one minute under a stream of water. The residue quantity left on the sieve is then dried and weighed. According to ASTM C 618 standards, the retained material should not exceed 34% by weight. This test helps ensure that the fly ash has the necessary particle size distribution for the best performance in concrete applications.

### Method 4: Laboratory Concrete Mixing

Concrete mixtures with 0%, 20%, 30% and 40% replacement rates by mass of cement were designed to produce the mixes. The 0% replacement mixture was prepared for the control specimens which contained 100% type IL Portland limestone cement (PLC), and therefore no fly ash was included in the mixture. Table 3, which discloses the mixture proportions for the control specimens without fly ash, the mixture with 20%, 30%, and 40% fly ash replacement levels. A constant 0.45 water-to-cementitious material ratio (w/cm) was used for all the mixtures. These concrete mixtures were made to produce a reasonable slump without using any chemical admixtures to minimize the variables.

TABLE 3
Mix Design Weights (lb./cy) using 0.45 w/cm

| Replacement | 0% | | | |
|---|---|---|---|---|
| Level | (Control) | 20% | 30% | 40% |
| Cement (PLC) | 610 | 488 | 427 | 366 |
| Fly Ash | 0 | 122 | 183 | 244 |
| Coarse I (RS 57) | 1840 | 1820 | 1810 | 1805 |
| Fine | 1215 | 1205 | 1200 | 1195 |
| Water | 274 | 274 | 274 | 274 |

In the laboratory, the aggregates used for the mixtures were collected from outside stockpiles and brought into a temperature-controlled room set at 73° F. (23° C.) for a minimum of 24 hours prior to the mixing process. The aggregates were spun in a mixing drum for a minimum duration of three minutes. A representative sample was utilized to conduct moisture content testing and subsequently apply a moisture correction to the mixture. During the mixing process, all aggregates were placed into the mixer, along with about two-thirds of the total amount of water used for mixing. The blend was mixed for a duration of three minutes to provide the saturated surface dry condition (SSD) of the aggregate surface and achieve uniform distribution of the aggregates. After that, the cement, fly ash, and the remaining water were added and the whole blend was mixed for a duration of three minutes. The resultant mix was allowed to rest for a duration of two minutes, during which the sides of the mixing drum were scraped.

### Method 5: Fresh Concrete Testing

A 2.3 cubic ft concrete mixture was prepared in a drum mixer. After the mixing period The Slump test was performed to help provide insight into the consistency of workability of the concrete mixtures. The Slump Test ASTM C143 has been the most specified workability test; however, it simply measures the ability of a cone of concrete to deflect after removing forms.

In addition to that, a sample with a volume of 0.25 cubic feet was tested using the gravimetric method ASTM C138 to determine the density, and the pressure method ASTM C231 to determine the air content. The concrete utilized for the slump test was returned back into the mixer, while the concrete utilized for the air content testing was disposed of. A 0.058 cubic foot sample was also utilized to measure the water content using the Phoenix test.

### Method 6: Slump Test ASTM C143

The Slump Test, as defined by ASTM C143, is a standard method used to measure the consistency and workability of fresh concrete. The test involves filling a cone-shaped mold, known as a slump cone, with fresh concrete in three layers, each compacted with a tamping rod 25 times. The cone is then carefully lifted vertically, allowing the concrete to slump. The decrease in the height of the concrete from its original height in the cone, known as the slump, is measured. The Slump test was used to help provide insight into the consistency of workability of the concrete mixtures. The Slump Test has been the most specified workability test. However, it simply measures the ability of a cone of concrete to deflect after removing forms.

### Method 7: Gravimetric Method ASTM C138

The Gravimetric Method, as described by ASTM C138, is a standard procedure used to determine the density (unit weight) of fresh concrete. The test involves filling a known-volume container with 3 layers of fresh concrete and consolidating each layer 25 times using a tamping rod. The concrete is then leveled off at the top of the container, and any excess is removed. The filled container is weighed, and the mass of the concrete is recorded. The density of the concrete is calculated by dividing the mass of the concrete by the volume of the container.

### Method 8: Pressure Method ASTM C231

The Pressure Method, as outlined in ASTM C231, is a standard procedure used to determine the air content of freshly mixed concrete. This method involves using a specialized device called a Type B air meter but in the experiments the SAM device is used, which is similar to the ASTM C231 Type B meter with some modifications. The SAM device uses six restricted clamps to account for increased pressures and a digital pressure gauge for testing. The test begins by filling the device container with three layers of fresh concrete and compacting each layer 25 times using a tamping rod to ensure a consistent sample. The lid of the SAM device is then secured, and water is added to cover the concrete surface. The device's pressure chamber is pressurized with air, and the pressure is then released into the container, compressing the air bubbles present in the concrete. The digital pressure gauge reading, which is the air content percentage, is then recorded. This method is widely used in the field because it provides a quick and accurate measurement of the total air content, which is crucial for understanding the durability and freeze-thaw resistance of the concrete.

### Method 9: Phoenix Test

The water content in concrete is measured using The Phoenix, which can then be used to calculate the water-to-cementitious material ratio (w/cm) of fresh concrete. This ensures that the mixture contains the correct amount of water. The process begins by creating and weighing a 3.5-inch tall by 6-inch diameter cylinder of fresh concrete, a volume found to provide consistent unit weight and w/cm. The cylinder is filled and consolidated according to ASTM C31 to maintain a constant volume for testing. Next, the concrete is transferred to a pan, spread uniformly to a thickness of ¾ inch. The pan is weighed before and after heating to determine water loss from the concrete. The sample is considered dry when the combined mass of the pan and concrete is 2 grams or less than the previous measurement taken at least 2 minutes apart during heating. The final mass represents the total water evaporated, including the absorbed water in the aggregates. To calculate the w/cm, the batch material weights, aggregate specific gravity, aggregate absorption, binder specific gravities, air volume, and total batch volume are needed. The air volume in the concrete can be determined using ASTM C231 or theoretical density calculations per ASTM C138. While the Phoenix measures the water content directly, calculations are necessary to estimate the w/cm. The w/cm ratio is crucial as it is a commonly specified parameter in concrete mixture standards.

### Method 10: Hardened Concrete Testing

### Method 10-1: Compressive Strength Test ASTM C39

For Stage I, nine 4×8 in. concrete cylinders were made and cured for each mix according to ASTM C192 for compressive strength testing ASTM C39. The cylinders were cured in an environmentally controlled room at a temperature of 73° F. and 100% relative humidity. The cylinders were kept in this room until compressive strength testing at 3, 7, and 28 days. The average load and stress were recorded for all three samples. For Stage II, 18 cylinders were made the same way described for Stage I to test the compressive strength at each curing time of 3, 7, 28, 56, 90, and 180 days.

### Method 10-2: Electrical Resistivity Test AASHTO T358

A non-destructive surface resistivity test using the four-point Wenner probe was conducted to measure the electrical resistivity of concrete in accordance with AASHTO T358. Measurements were taken at 3, 7, 28, 56, and 90 days of hydration. Measurements were taken from three cylinders, resulting in twelve measurements for each fly ash concrete at each curing time. The average of these twelve measurements represented the electrical resistivity for each fly ash at each specific curing time. All specimens were in a saturated surface-dry (SSD) condition during the tests.

### Example 2: Results and Discussion

This section presents the findings from the experimental study conducted in two stages to evaluate the influence of harvested fly ash fineness on concrete properties. Stage I involved creating nine concrete mixes using harvested fly ash samples from the same source, categorized into three groups based on fineness levels: low fineness (<15%), medium fineness (30%<Fineness <36%), and high fineness (>75%). The compressive strength of these samples was tested over a 28-day period to assess the initial impact of fly ash fineness on concrete strength.

Stage II was designed based on the insights gained from Stage I. In this stage, eleven additional concrete mixes were prepared, including a control mix without fly ash and ten mixes incorporating fly ash from the same source. The samples were prepared with three different fineness levels (10%, 23%, and 74%), and three concrete mixes were created for each fineness level with varying replacement rates of 20%, 30%, and 40%. Additionally, one sample was prepared with fly ash ground to a very fine particle size of 2% fineness to explore the effects of ultra-fine particles on concrete properties. These mixes underwent comprehensive testing, including fresh concrete properties (slump, unit weight, air content, and water-to-cement ratio using the Phoenix method) and hardened concrete properties (compressive strength and electrical resistivity) over a 180-day period.

### Stage I Results

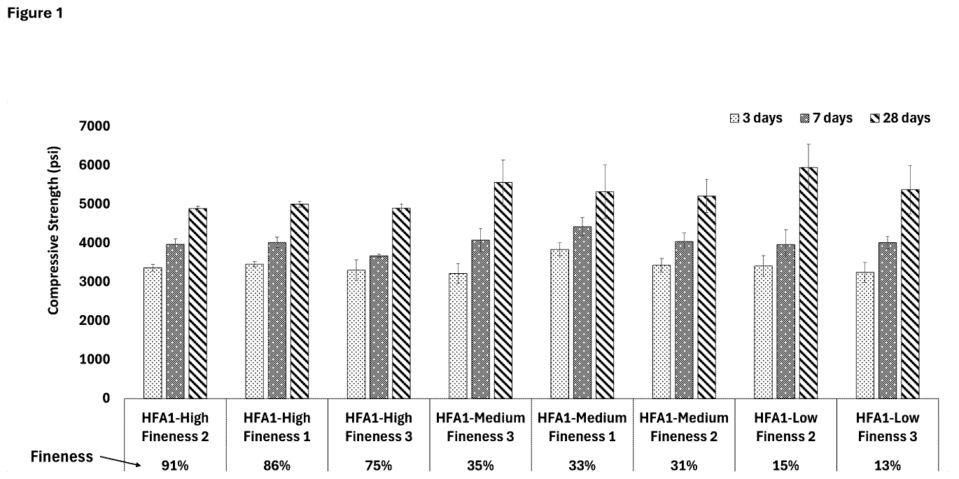

After analyzing the compressive strength results for all nine mixes at 3, 7, and 28 days, disclosed in FIG. 1, it has been observed that the differences between the various fineness categories appeared to be minimal. To confirm that these differences are statistically insignificant, the ANOVA (Analysis of Variance) test was performed, which is a statistical method used to compare means among three or more groups to see if at least one group's mean is significantly different from the others. The F-statistic in ANOVA indicates the ratio of variance between the groups to the variance within the groups, and the p-value helps determine if the observed differences are statistically significant. A p-value less than 0.05 typically indicates a significant difference.

In this study the ANOVA test was conducted to determine if there are any significant differences in the compressive strength of concrete mixes using harvested fly ash with different levels of fineness (low, medium, and high) at three different testing periods (3 days, 7 days, and 28 days). The fly ash used in the concrete mixes is categorized based on its fineness and the test aims to see if this categorization affects the compressive strength over time.

The results from Table 4, disclosing the ANOVA statistical analysis test results for Stage I, demonstrate that at 3 days the p-value was 0.882, indicating no significant difference between the different fineness categories. At 7 days, the p-value was 0.090, which is slightly above the significance threshold of 0.05, suggesting a non-significant difference in compressive strength between the fineness categories at this curing time. Similarly, at 28 days, the p-value was 0.07. Overall, the analysis suggests no significant differences in compressive strength due to the fineness levels of the fly ash at any of the testing periods and, according to these results obtained from stage I, it was decided to proceed to stage II and make further studies to establish a definitive correlation between fineness and compressive strength at extended curing periods.

TABLE 4

| Day | F-Statistic | P-Value |
|---|---|---|
| 3 Days | 0.128 | 0.882 |
| 7 Days | 3.701 | 0.090 |
| 28 Days | 4.146 | 0.074 |

### Stage II Results

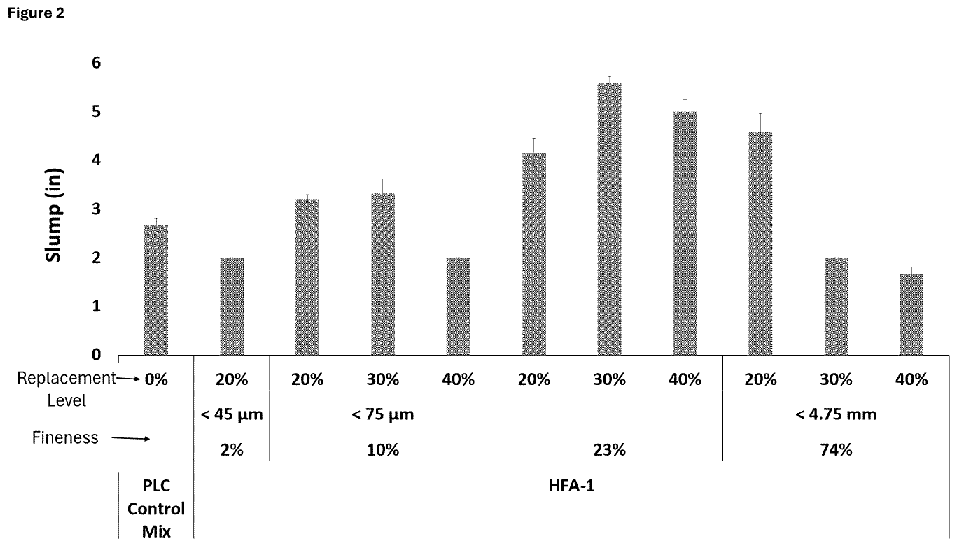

FIG. 2 and Table 5 disclose results and slump values for different concrete mixes utilizing harvested fly ash from the same source, with various replacement levels (20%, 30%, and 40%). The fineness of the fly ash is indicated as percentages at the bottom of the graph. A slump is a common measure of workability and reflects how easily fresh concrete can be mixed, placed, compacted, and finished, with higher slump values indicating higher workability.

TABLE 5

| Source | | Slump | | Pheonix | Unit Wt. | Air |
|---|---|---|---|---|---|---|
| Name | Sample Name | (in) | STDV | w/cm | (lb/cft) | Content % |
| No Fly | PLC (Control Mix) | 2.7 | 0.1 | 0.45 | 149.8 | 2.0 |
| Ash | <45 μm 20% | 2.0 | 0.0 | 0.45 | 149.0 | 1.8 |
| | <75 μm 20% | 3.2 | 0.1 | 0.45 | 149.4 | 1.9 |
| | <75 μm 30% | 3.3 | 0.3 | 0.43 | 150.4 | 2.0 |
| | <75 μm 40% | 2.0 | 0.0 | 0.43 | 148.4 | 1.9 |
| | 75 μm < Particle | 4.2 | 0.3 | 0.46 | 148.3 | 2.2 |
| | Size < 4.75 mm 20% | | | | | |
| HFA-1 | 75 μm < Particle | 5.6 | 0.1 | 0.43 | 146.7 | 2.2 |
| | Size < 4.75 mm 30% | | | | | |
| | 75 μm < Particle | 5.0 | 0.3 | 0.45 | 146.5 | 2.2 |
| | Size < 4.75 mm 40% | | | | | |
| | <4.75 mm 20% | 4.6 | 0.4 | 0.46 | 149.0 | 1.8 |
| | <4.75 mm 30% | 2.0 | 0.0 | 0.43 | 147.7 | 1.7 |
| | <4.75 mm 40% | 1.7 | 0.1 | 0.43 | 147.8 | 1.8 |

Comparing the slump results for the ash utilized in this study ground to a fineness of 2% versus the ash with a fineness of 10%, a lower slump for the 2% fineness ash was observed. This suggests that an excessive amount of ultra-fine particles have a high enough surface area that impacts the water demand of the mixture, thus resulting in a lower slump. Additionally, the ash with a fineness of 23% shows higher slump values than the control mix and higher than the mixes using either 74% fineness ash or ash with 10% fineness alone. The blend may create a more optimal particle size distribution, where fine particles fill the voids between coarse particles, leading to a denser packing of particles. Using fine ash alone (10% fineness) can produce an overly cohesive mix, reducing workability, while coarse ash alone (74% fineness) can result in poor packing and higher void content, also reducing workability. The blended ash balances these effects, resulting in a mix that is neither too cohesive nor too segregated.

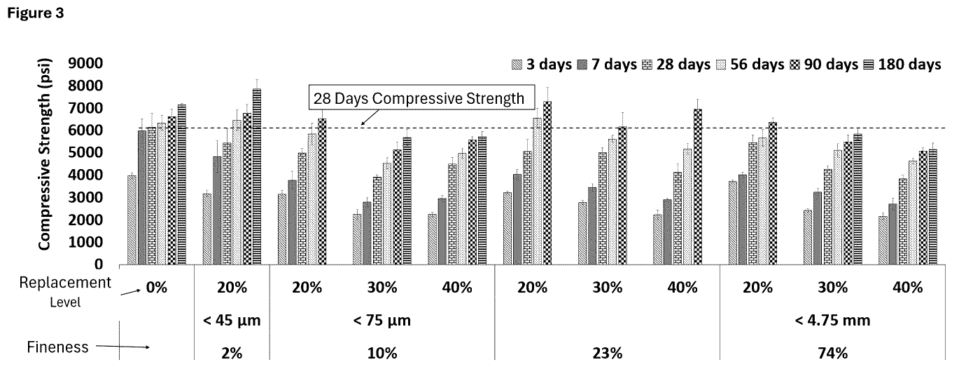

FIG. 3 discloses the compressive strength of various concrete mixes using the same source of harvested fly ash with different gradations and replacement levels. The PLC control mix generally outperforms the fly ash mixes at early curing periods (3, 7, and 28 days). At early ages, coarse ash (<4.75 mm) performed almost the same as the fine ash mixes (<75 μm) and blends that has a fineness of (23%). Using blended ash improved compressive strength, achieving higher results than both fine and coarse ashes at 90 days. This suggests a synergistic effect where the combination of different particle sizes enhances packing density and efficiency, contributing to strength gains comparable to those with fine ash. The very fine ash produced after 20 minutes of grinding performed better than other mixes with higher fineness numbers at early ages. At late ages, it didn't perform significantly differently from the other mixes, reinforcing the idea that factors other than just particle size such as curing conditions, chemical composition, and particle packing are contributing to the compressive strength.

When comparing the compressive strength of the mixes with a 20% replacement level, the control mix consistently demonstrates high strength. This is because it contains a higher portion of cement compared to the other mixes, which aids in the early formation of calcium silicate hydrate (C-S-H). This mixture serves as a benchmark as it contains no fly ash. The fine fly ash (<75 μm) has a high degree of fineness, increasing its surface area and resulting in slightly higher early strength compared to mixes with coarser ash. In this study, there is no significant difference in compressive strength when using fine ash (<75 μm) and coarse ash (<4.75 mm). It is hypothesized that the coarse ash may break down during mixing. This could explain why this material performs similar to the finer materials.

The blended mix (4.75 mm>Particle Size>75 μm) with 20% replacement starts with moderate compressive strength at 3 days and maintains a steady increase, exhibiting strong performance at 56 and 90 days, even surpassing the control mix at certain points. The combination of fine ash with a fineness of 10% and coarse ash ground for 250 revolutions to achieve 23% fineness creates a better particle packing density. Fine particles fill the voids between the coarser particles, leading to a denser and more compact concrete matrix which may reduce porosity and increases the overall strength. To assess the impact of increased fly ash fineness on the strength characteristics of concrete over time, fly ash was ground at 1400 revolutions to achieve a fineness of 2% and use it with 20% replacement in the concrete mix. Compressive strength measurements were taken at different curing time 3, 7, 28, 56, 90, and 180 days. The early strength at 3 and 7 days was significantly higher for the PLC mixture compared to other mixes. However, from 28 days onward, including longer curing periods of 90 and 180 days, the results were very comparable to those of mixes incorporating fine, coarse, and blended fly ash samples.

The 40% replacement mixes exhibited lower compressive strength at all ages compared to the 20% replacement mixes. This trend is particularly noticeable across all tested samples. However, the blend 40% replacement mix showed substantial gains in compressive strength at 28, 56, and 90 days, outperforming many other 40% mixes and indicating significant long-term strength development. The blended mix includes a combination of fine and coarse particles, which might optimize the particle packing density and reduce void spaces during the production of hydration products. This leads to a denser and more cohesive matrix, enhancing compressive strength. Increasing the replacement level from 20% to 40% generally led to a reduction in early age compressive strength. However, at later ages, most of these mixes showed less negative impact and demonstrated improved long-term strength performance.

The performance of fly ash in concrete is traditionally linked to its fineness, with finer ashes believed to enhance concrete properties due to their higher reactivity. However, this work shows that coarser fly ash can achieve about the same level of performance, which presents significant advantages for the industry. Avoiding extensive sieving or grinding of harvested fly ash can significantly cut production costs and reduce the energy required for grinding, leading to more sustainable and cost-effective production. The ability to use both fine and coarse fly ash increases their potential for use in various concrete mixtures, helping concrete producers adapt to variations in fly ash supply and ensuring consistent product quality and performance.

The current ASTM C 618 standard specifies a fineness limit of 34% retained on the 45 μm sieve. However, these findings suggest that this limit may need re-evaluation. It is important to note that not all fly ashes are the same; their properties, including fineness and chemical composition, vary significantly depending on the source and combustion process.

To determine if there are any significant differences in the compressive strength, the Kruskal-Wallis test was employed to compare the compressive strength results of different concrete mixes. Kruskal-Wallis test results for comparison of compressive strength with different fineness is disclosed in Table 6. The analysis were performed on the results for mixes that utilize 20% fly ash replacement with different fineness levels, mixes that use 30% replacement with different fineness levels, and mixes that use 40% replacement with different fineness levels. The comparisons are made for each testing day 3, 7, 28, 56, and 90 days. This approach allows an assessment if the variations in fineness and the percentage of fly ash replacement result in statistically significant differences in the compressive strength of the concrete over time. The Kruskal-Wallis test provides a robust method to handle the non-parametric nature of the data is used to ensure the validity of comparison across different mix compositions and testing periods.

TABLE 6

| Mixes used 20% replacement level | | | Mixes used 30% replacement level | | | Mixes used 40% replacement level | | |
|---|---|---|---|---|---|---|---|---|
| Testing Day | H-Value | P-value | Testing Day | H-Value | P-value | Testing Day | H-Value | P-value |
| 3 | 6.44 | 0.09 | 3 | 5.96 | 0.06 | 3 | 1.16 | 0.56 |
| 7 | 3.82 | 0.28 | 7 | 5.56 | 0.08 | 7 | 1.69 | 0.43 |
| 28 | 2.38 | 0.50 | 28 | 7.20 | 0.03 | 28 | 4.36 | 0.11 |
| 56 | 6.23 | 0.10 | 56 | 6.49 | 0.04 | 56 | 5.96 | 0.06 |
| 90 | 4.85 | 0.18 | 90 | 5.07 | 0.08 | 90 | 5.42 | 0.07 |

Based on a 95% confidence level, the compressive strength results were compared across four different fineness levels for mixes with 20% replacement level. The degree of freedom (df) for this test is calculated as the total number of groups being compared minus one (df=t−1), which in this case is 4−1=3. Using the Chi-Squared distribution, the critical value at a 95% confidence level for 3 degrees of freedom is χ_{0.05,3}²=7.815.

From the statistical analysis, all values of the test statistic (H) were found to be lower than 7.815. This indicates that there are no statistically significant differences in the distributions of compressive strength across the different fineness levels for each testing day. In other words, the compressive strength values for each fineness level are similarly distributed and are centered around the mean value for each testing day.

For mixes with 40% and 30% replacement levels, the degree of freedom is equal to 3−1=2, then the critical value according to the Chi-Squared distribution at a 95% confidence level for 2 degrees of freedom is χ_{0.05,2}²=5.991. All values of the test statistic (H) for 40% replacement mixes were found to be lower than 5.991. This indicates that there are no statistically significant differences in the distributions of compressive strength across the different fineness levels for each testing day for mixes with 40% replacement. Similarly for 30% replacement, a degree of freedom of 2 were used to make the comparison and two values were higher than the critical value 5.991 at 28 and 56 days and for these two samples there might be a difference; however, with more testing it is likely that these samples are not statistically different.

Electrical resistivity is being evaluated as a method to assess mass transport into concrete and has been proposed as a quality control tool for concrete. The mass transport of deleterious ions into concrete can significantly affect the lifespan of concrete structures. The resistance of concrete against ion ingress is one of the most important factors for designing durable concrete structures. The results obtained from this test could be of great value because of the low cost, speed, and convenience of performing electrical resistivity measurements.

Several factors influence the performance of electrical resistivity, including cement chemistry, cement content, water-to-cement ratio, admixtures, and supplementary cementitious materials such as fly ash. Generally, electrical resistivity increases over time for all mixes in this study, indicating that it is harder to transfer electrons as the concrete cures.

For early ages, the control mix achieved slightly higher resistivity than all other mixes, but at 28 days and beyond, all mixes produced higher resistivity. Mixes with 40% fly ash replacement tend to show higher electrical resistivity compared to 20% and 30% replacements. This might be due to the increased pozzolanic reaction of the fine fly ash particles over time at higher replacement levels, which refines the pore structure. Mixes using fine fly ash particles (<75 μm) tend to enhance resistivity more than coarser particles (<4.75 mm). This could be because finer particles fill the pores more efficiently, reducing ionic movement. The finer particles also may create greater changes to the pore solution of the concrete. The mix with 20% fly ash replacement and 2% fineness outperforms all other mixes at this replacement level in terms of electrical resistivity at all time points, suggesting it provides the best resistance to electrical flow. It shows a significant increase in resistivity, particularly notable at 28 days, and the highest resistivity at 180 days among all mixes with 20% replacement, reaching around 45 kΩ·cm.

Fly ash with a fineness of 10% and 23% also improves resistivity considerably, but to a lesser extent. The trend indicates that increasing fineness improves resistivity. The coarse ash (<4.75 mm) still improves resistivity compared to the control mix but is less effective than finer ashes. While it's still higher than the control mix, it shows the least improvement among the other fly ash mixes with 20% replacement, indicating that coarser particles are less effective in enhancing resistivity. It should be noted that all the fly ash mixtures showed significant improvement over the control. This shows that all of these materials are valuable.

Doubling the fly ash content from 20% to 40% significantly increases electrical resistivity across all levels of fineness. The impact is most pronounced with fine ash (10% fineness), where the resistivity at 20% replacement is 35 kΩ·cm, and the resistivity for the same fineness with 40% replacement is 56 kΩ·cm. The higher electrical resistivity observed with 40% fly ash replacement compared to 20% replacement can be attributed to several interrelated factors, such as enhanced pozzolanic reaction, which produces more calcium silicate hydrate (C-S-H), leading to a denser microstructure. Additionally, the increased fly ash content reduces the amount of conductive calcium hydroxide and further disrupting conductive pathways. The material may also change the pore solution chemistry of the concrete. Together, these factors create a more refined and less conductive matrix that significantly restricts electrical flow, thereby increasing resistivity with higher fly ash replacement levels.

### CONCLUSIONS

The findings from the above Examples demonstrate that achieving a balance between particle size distribution, chemical composition, and replacement levels is crucial for enhancing the strength, durability, and workability of concrete mixes.

The findings are summarized as follows:

Fly ash replacement at 20%, 30%, and 40% levels generally shows a slower early strength gain compared to the control mix. However, long-term strengths are comparable or exceed the control mix, particularly at higher replacement levels.

The blend of coarse and fine fly ash improves compressive strength, suggesting that an optimal particle size distribution enhances the packing density and efficiency of the concrete mix. Fine ash produced after extensive grinding does not significantly outperform other mixes in the long term, indicating the importance of factors such as chemical composition and reactivity in strength development.

Concrete mixes with higher fly ash replacement levels (40%) exhibit increased electrical resistivity over time, indicating enhanced durability. Fine fly ash particles contribute to higher resistivity by effectively filling concrete pores and reducing ionic movement, emphasizing the role of particle fineness in durability enhancements.

Higher fineness in fly ash leads to lower slump values due to increased water absorption by fine particles, reducing the amount of free water in the mix. Conversely, a blend of fine fly ash and coarser ash achieves more optimal workability, avoiding excessive cohesion or segregation, and results in higher slump values compared to using either type alone.

Making Concrete with Fly Ash

The steps of making concrete with fly ash, which may vary from time to time, conventionally involve the following process. The first step is to select the appropriate type of fly ash. Fly ash comes in two classes, Class F and Class C. Class F fly ash is low in calcium content and requires a pozzolanic activator, such as lime or Portland cement, to react and strengthen the concrete. Class C fly ash, on the other hand, is high in calcium and can be, in certain circumstances, self-cementing. Choosing the appropriate type of ash is highly important for each project according to project specifications. Fly ash can replace 15-30% of the Portland cement in a concrete mix, but in some cases, it can replace up to 50%. The exact percentage depends on the desired properties of the finished concrete, such as strength, setting time and other parameters. A typical mix might consist of Portland cement and 15-30% fly ash, along with aggregates like sand and gravel, and water.

As the second step, the concrete materials including Portland cement, fly ash, and aggregates are combined. Gradually water is added to the mix while continuously stirring to ensure uniform distribution. The water-cement ratio should be carefully controlled; too much water can weaken the concrete, while too little can make it difficult to work with. The goal is to achieve a homogeneous, workable mix with a consistent texture. Once the desired mixture is obtained, it is poured into a mold, form, or on-site location.

After pouring, a proper curing of the concrete is essential to achieve the desired strength and durability. Concrete made with fly ash typically requires a longer curing time than conventional concrete due to its slower rate of hydration. Curing can be done by maintaining moisture through water spraying, covering with wet burlap, or using curing compounds. Concrete typically needs to be cured for at least 7 to 28 days, depending on the specific mix and environmental conditions. After finishing the curing process, and achieving the desired strength, the concrete product can be used according to its specifications.

1. A method of making concrete, comprising mixing the following materials to a homogenous mixture, contemporaneously or consecutively:
a. cementitious binder comprising 5%-30% of the total concrete mixture weight;
b. fly ash having a particle size distribution retained rate of more than 34% percent when wet-sieved on 45 μm sieve and wherein said fly ash is present in a combined range of 5% to 50% by weight based on the total weight of the cementitious binder;
c. water in a combined range of 20% to 70% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 5% to 95% of the total concrete mixture by weight.

2. The method of claim 1, comprising mixing the following materials to a homogenous mixture, contemporaneously or consecutively:
a. cementitious binder comprising 10%-17% of the total concrete mixture weight;
b. fly ash having a particle size distribution retained rate of more than 34% percent when wet-sieved on 45 μm sieve and wherein said fly ash is present in a combined range of 20% to 40% by weight based on the total weight of the cementitious binder;
c. water in a combined range of 40% to 50% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 60% to 85% of the total concrete mixture by weight.

3. The method of claim 2, further comprising adding air-entraining agents to improve freeze-thaw resistance, wherein the air-entraining agents create a volume of air comprising between 1% and 12% of the mixture.

4. The method of claim 3, wherein the fly ash is dried to 3% or less water content.

5. The method of claim 4, wherein the cementitious binder is chosen from ordinary Portland cement, Portland limestone cement, blended cement, and calcium sulfoaluminate cement.

6. The method of claim 5, wherein the concrete has a slump of 1-9 inches.

7. The method of claim 1, wherein the fly ash is retained, when wet-sieved on 45 μm sieve, at a rate of more than 35%, 45%, 55%, 65%, 75%, 85% or 90%.

8. The method of claim 7, wherein the retention rate is more than 45%, 65% or 85%.

9. The method of claim 8, wherein the retention rate is more than 45%.

10. A fly ash comprising:
i. a chemical composition comprising silica, alumina and iron oxides being a minimum of 50% of fly ash mass;
ii. moisture of up to 3%;
iii. a loss on ignition of up to 6%;
iv. a sulfur trioxide concentration of not more than 5%;
v. a strength activity index of no less than 75% as compared to a control mixture with Portland cement alone;
vi. an autoclave expansion of no more than 0.8%;
vii. a water requirement of no more than 105% as compared to a control mixture with Portland cement alone; and
viii. having a particle size distribution retention rate of more than 34% percent when wet-sieved on 45 μm sieve.

11. The fly ash of claim 10, wherein the fly ash is class C fly ash.

12. The fly ash of claim 10, wherein the fly ash is class F fly ash.

13. The fly ash of claim 12, wherein the fly ash is harvested fly ash.

14. A storage silo comprising the fly ash of claim 10.

15. A truck comprising a dry bulk enclosed trailer loaded with the fly ash of claim 10.

16. A concrete mix comprising:
a. cementitious binder comprising 5%-30% of the total concrete mixture weight;
b. fly ash having a particle size distribution retained rate of more than 34% percent when wet-sieved on 45 μm sieve and wherein said fly ash is present in a combined range of 5% to 50% by weight based on the total weight of the cementitious binder;
c. water in a combined range of 20% to 70% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 5% to 95% of the total concrete mixture by weight.

17. The concrete mix of claim 16, comprising:
a. cementitious binder comprising 10%-17% of the total concrete mixture weight;
b. fly ash having a particle size distribution retained rate of more than 34% percent when wet-sieved on 45 μm sieve and wherein said fly ash is present in a combined range of 20% to 40% by weight based on the total weight of the cementitious binder;
c. water in a combined range of 40% to 50% by weight based on the total weight of the cementitious binder and fly ash; and
d. aggregates selected from the group of gravel, stone, crushed stone, sand, slag, recycled concrete, geosynthetic aggregates, or mixtures thereof, wherein said aggregates are present in a range of 6% to 85% of the total concrete mixture by weight.

18. The concrete mix of claim 17, having a slump measured by (i) filling a slump cone with fresh concrete in three layers, (ii) compacting each layer with a tamping rod, (iii) vertically removing the slump cone, (iv) allowing the concrete to slump, and (v) measuring the decrease in concrete height, of between 1 and 9 inches.

19. The concrete mix of claim 17, having a compressive strength between 3,000 and 8,000 PSI.

20. A block or brick comprising the concrete mix of claim 17.
